(19) United States
(12) Patent Application Publication
(10) Pub. No.: US 2024/0387104 A1
(43) Pub. Date: Nov. 21, 2024

(54) METHOD AND APPARATUS FOR PRODUCING MULTILAYER BODY OF RAPIDLY QUENCHED SOFT MAGNETIC ALLOY RIBBONS

(71) Applicant: Proterial, Ltd., Tokyo (JP)

(72) Inventor: Kousei Hosokawa, Tokyo (JP)

(73) Assignee: Proterial, Ltd., Tokyo (JP)

(21) Appl. No.: 18/691,046

(22) PCT Filed: Sep. 26, 2022
(86) PCT No.: PCT/JP2022/035778

§ 371 Date: Mar. 12, 2024

(30) Foreign Application Priority Data
Sep. 28, 2021 (JP) 2021-158104

(51) Int. Cl. H01F 41/12; H01F 41/063

(52) U.S. Cl. CPC H01F 41/125; H01F 41/063

(57) ABSTRACT

A method for producing a multilayer body of rapidly quenched soft magnetic alloy ribbons, in which a plurality of rapidly quenched soft magnetic alloy ribbons having a thickness of about 10 to 50 μm and a width of about 10 to 250 mm are bonded together, includes: a resin application step in which a resin adhesive, which is an epoxy resin, is applied to at least one surface of at least one rapidly quenched soft magnetic alloy ribbon without being diluted with organic solvents; a stacking step in which, on the surface of the rapidly quenched soft magnetic alloy ribbon to which the resin adhesive is applied in the resin application step, another rapidly quenched soft magnetic alloy ribbon is stacked; and a heat treatment step in which the rapidly quenched soft magnetic alloy ribbons stacked in the stacking step are heated and bonded together to obtain a multilayer body.

### TECHNICAL FIELD

The present invention relates to a method for producing a multilayer body of rapidly quenched soft magnetic alloy ribbons stacked and bonded using a resin adhesive and an apparatus for producing a multilayer body.

[Background Art]

Since rapidly quenched soft magnetic alloy ribbons (for example, amorphous alloy thin ribbons and nanocrystalline alloy thin ribbons) have no magnetic anisotropy, and the movement of magnetic domain boundaries is smooth, they have a high magnetic flux density and high permeability, and excellent magnetic properties with low loss. In the production of products using soft magnetic alloy thin ribbons such as amorphous alloy thin ribbons, techniques for improving processability and handling properties by bonding a plurality of amorphous alloy thin ribbons to form a multilayer body have been developed.

Patent Literature 1 discloses a magnetic substrate in which a heat-resistant resin (preferably, an aromatic polyimide resin represented by a predetermined chemical formula) is applied to an amorphous alloy thin ribbon containing Fe or Co as a main component, and a multilayer body in which the magnetic substrates are stacked and bonded together in a pressure range of 0.01 to 500 MPa and heated at a temperature of 300° C. to 500° C., for 10 minutes to 5 hours to improve magnetic properties. After various examinations of the composition of the amorphous alloy thin ribbon and the type of the heat-resistant resin, it has been shown that the relative permeability, core loss, and tensile strength of the multilayer body reached desired values.

Patent Literature 2 also discloses a method for making a multilayer body by stacking and heating amorphous alloy thin ribbons. Specifically, it discloses that, when an adhesive (a polyester imide-based resin or a phenoxy resin) is applied to an amorphous alloy thin ribbon and the sample is put into a drying furnace for 1 minute to volatilize a solvent, pressed with a reduction roller, and annealed in a magnetic field at a heating temperature of 300 to 500 degrees for about 1 minute to about 100 minutes, excellent magnetic properties are obtained.

### CITATION LIST

### Patent Literature

### [Patent Literature 1]

Japanese Patent No. 4537712

### [Patent Literature 2]

Japanese Patent Laid-Open No. S58-175654

### SUMMARY OF INVENTION

### Technical Problem

When a plurality of rapidly quenched soft magnetic alloy ribbons are bonded together to form a multilayer body, in order to obtain a high space factor, it is necessary to thin the adhesive layer and control the film thickness. On the other hand, there is a problem that it is difficult to apply a thin adhesive while maintaining a high viscosity without diluting it with an organic solvent (reducing viscosity and improving wettability).

Here, an objective of the present invention is to provide a method for producing a multilayer body of rapidly quenched soft magnetic alloy ribbons, which is suitable for obtaining a multilayer body having a high space factor, by thinly and uniformly applying a resin which is a highly viscous adhesive to rapidly quenched soft magnetic alloy ribbons.

### Solution to Problem

The present invention provides a method for producing a multilayer body of rapidly quenched soft magnetic alloy ribbons, in which a plurality of rapidly quenched soft magnetic alloy ribbons are bonded together, including:

a resin application step in which a resin adhesive is applied to at least one surface of at least one rapidly quenched soft magnetic alloy ribbon;

a stacking step in which, on the surface of the rapidly quenched soft magnetic alloy ribbon to which the resin adhesive is applied in the resin application step, another rapidly quenched soft magnetic alloy ribbon is stacked; and

a heat treatment step in which the rapidly quenched soft magnetic alloy ribbons stacked in the stacking step are heated and bonded together to obtain a multilayer body.

wherein the method for applying the resin adhesive is a flexographic printing method.

In addition, in the flexographic printing method, it is preferable to use an elastic member having a plurality of convex parts for a printing cylinder.

In addition, it is preferable to provide an unwinding step in which the rapidly quenched soft magnetic alloy ribbon is unwound from a coil-shaped wound body before the resin application step, and a winding step in which the multilayer body is wound into a coil to form a wound multilayer body after the stacking step.

In addition, the resin adhesive is preferably an epoxy resin.

The present invention provides an apparatus for producing a multilayer body of rapidly quenched soft magnetic alloy ribbons, in which a plurality of rapidly quenched soft magnetic alloy ribbons are bonded together, including:

a resin application unit configured to apply a resin adhesive to at least one surface of at least one rapidly quenched soft magnetic alloy ribbon;

a stacking unit configured to stack, on the surface of the rapidly quenched soft magnetic alloy ribbon to which the resin adhesive is applied by the resin application unit, another rapidly quenched soft magnetic alloy ribbon; and

a heat treatment unit configured to heat and bond the rapidly quenched soft magnetic alloy ribbons stacked by the stacking unit to obtain a multilayer body.

wherein the method for applying the resin adhesive is a flexographic printing method.

### Advantageous Effects of Invention

According to the present invention, it is possible to provide a method for producing a multilayer body of rapidly quenched soft magnetic alloy ribbons, including applying a resin which is a highly viscous adhesive to a rapidly quenched soft magnetic alloy ribbon, and which is suitable for obtaining a high space factor.

### BRIEF DESCRIPTION OF DRAWINGS

FIG. 1a is an example of a form of a flexographic printing device.

FIG. 1b is an example of a form of a flexographic printing device.

FIG. 1c is an example of a form of a flexographic printing device.

FIG. 2 is an example of an anilox roller with an octagonal cell shape.

FIG. 3a is an example of a schematic cross-sectional view of a rapidly quenched soft magnetic alloy ribbon to which a resin adhesive is applied.

FIG. 3b is an example of a schematic cross-sectional view of a rapidly quenched soft magnetic alloy ribbon to which a resin adhesive is applied.

FIG. 4a is an example of a printing cylinder having a convex part having a dot pattern shape.

FIG. 4b is an example of a printing cylinder having a convex part having a stripe pattern shape.

FIG. 5 is an example of a step when a test piece of a multilayer body is produced.

FIG. 6 is an example of a step of producing a multilayer body according to a continuous production method.

FIG. 7a is an example of a form of a resin application step when there are three rapidly quenched soft magnetic alloy ribbons.

FIG. 7b is an example of a form of a resin application step when there are three rapidly quenched soft magnetic alloy ribbons.

FIG. 7c is an example of a form of a resin application step when there are three rapidly quenched soft magnetic alloy ribbons.

FIG. 7d is an example of a form of a resin application step when there are three rapidly quenched soft magnetic alloy ribbons.

FIG. 8 is an example of an external view of a 180-degree peel testing machine.

FIG. 9 is an example of a diagram showing points at which the film thickness of a thin ribbon and a multilayer body are measured.

### DESCRIPTION OF EMBODIMENTS

Hereinafter, embodiments of a method for producing a multilayer body according to the present invention will be described in detail with reference to the drawings. However, the present invention is not limited to the following embodiments. In addition, for clarity of explanation, the following description and drawings are appropriately simplified.

### Rapidly Quenched Soft Magnetic Alloy Ribbon

A rapidly quenched soft magnetic alloy ribbon is produced by quenching a molten alloy with a roller and forming it into a thin ribbon. Generally, after the ribbon is produced, it is cut into a predetermined size and width and wound into a coil. The width after cutting is, for example, about 10 mm to about 1 m.

The material of the rapidly quenched soft magnetic alloy ribbon according to the present invention is not particularly limited, and for example, Fe-based amorphous alloy thin ribbons such as 2605HB1M materials (commercially available from Hitachi Metals, Ltd. or commercially available from Metglas) can be used. “2605HB1M” is a registered trademark (commercially available from Hitachi Metals, Ltd.). Alternatively, it is also possible to use an Fe-based nanocrystalline alloy thin ribbon in which nanocrystals are crystallized by subjecting a rapidly quenched soft magnetic alloy ribbon to a heat treatment.

Hereinafter, the rapidly quenched soft magnetic alloy ribbon and the nanocrystalline alloy thin ribbon will be collectively referred to as “thin ribbons.” The thickness of these thin ribbons is not particularly limited, and for example, is 10 to 50 μm, and preferably 10 to 30 μm.

### Resin Adhesive

The resin according to the present invention is used to bond thin ribbons together by heating. The type of resin can be selected from among, for example, polyimide-based resins, epoxy resins, ketone-based resins, polyamide-based resins, nitrile-based resins, thioether-based resins, polyester-based resins, arylate-based resins, sulfone-based resins, imide-based resins, and amide imide-based resins.

Among these, for example, polyimide resins and polyimide amide resins are generally used after being diluted with organic solvents, but many of these organic solvents are harmful to humans and the environment, and some are flammable or combustible. Various measures are necessary for handling, which leads to larger facilities, more complicated management, and higher costs. On the other hand, epoxy resins are very cheap and easily available, and do not require mixing with organic solvents, making them safe and suitable for mass production. Therefore, an epoxy resin is preferable.

Generally, properties of epoxy resins are evaluated by thermogravimetry (TG), differential thermal analysis (DTA), differential scanning calorimetry (DSC), a thermo-mechanical analysis (TMA) device or the like. Epoxy resins tend to have higher viscosity as the heat resistant temperature becomes higher. The high viscosity in the present embodiment is specifically, 0.1 Pa·s or more.

Epoxy resins are of a one-liquid type that contains a curing agent in advance and is cured by heating and a two-liquid type that is cured at room temperature by adding a curing agent when used. Although not particularly limited, it is desirable to use a one-liquid type because it requires less time and labor for setting up. As a one-liquid type epoxy resin, for example, E-530 (commercially available from SOMAR Corporation) can be used. The resin has a viscosity of 2 Pa·s (25° C.) and a glass transition point Tg of 179 degrees (catalog value) in TMA. The glass transition point Tg described below is a Tg measured by the thermo-mechanical analysis device TMA.

Here, the space factor will be described. The space factor is a ratio indicating the degree of a base occupied with respect to the apparent size of the multilayer body, and is represented, in the case of a multilayer body using thin ribbons, by space factor (%)−((the thickness of the thin ribbon×the number of stacked ribbons)/stacking thickness after stacking)×100%.

For example, when the thickness after two thin ribbons with a thickness of 25 μm are bonded together via a resin adhesive is 52 μm, the space factor is 25×2/52=96.2%. Since actual thin ribbons vary in thickness, the thickness is measured at a plurality of points, and the average value thereof may be used as a thickness average in calculations.

In order to achieve excellent magnetic properties of the multilayer body, it is preferable to minimize the amount of the resin adhesive applied and achieve a high space factor. The high space factor is preferably 90% or more, more preferably 95% or more, and still more preferably 98% or more. On the other hand, when the thickness of the resin adhesive is too thin, since there is a concern that the adhesive force will become insufficient, the space factor is preferably 98% or less.

In order to obtain a space factor of 90% or more, the thickness of the resin when the resin adhesive is applied and the thin ribbons are bonded together and heated is preferably 5.5 μm or less, and in order to obtain a space factor of 95% to 98%, the thickness is more preferably 1.0 to 2.5 μm. If the resin adhesive is applied and heated without bonding the thin ribbons together, the film thickness of the resin tends to become thicker because there is no pressing pressure during bonding. In this case, the film thickness is preferably, for example, about 2 to 7 μm, and in order to further increase the space factor, the film thickness is preferably 2 to 4 μm. In order to obtain these film thicknesses, the viscosity when the resin adhesive is applied is preferably 30 Pa·s or less, and more preferably 8 Pa·s or less.

When the viscosity of the resin adhesive exceeds the above upper limit value, the film thickness may not be stable. This is speculated to be due to the fact that, in a flexographic printing method to be described below, it is difficult for the resin adhesive to reach the end of the cell of the anilox roller, or it is difficult for the resin adhesive that has come into contact with the doctor blade to be separated from the blade. In such a case, it is preferable to heat the resin adhesive in advance (for example, to 40° C.) because this will increase the fluidity.

An embodiment of a method for producing a multilayer body according to the present invention will be described in order of steps.

### Resin Application Step

First, a resin adhesive is applied to at least one surface of at least one rapidly quenched soft magnetic alloy ribbon. In order to obtain a multilayer body with a high space factor by applying a highly viscous resin adhesive such as an epoxy resin thinly and uniformly to an uneven thin ribbon, the flexographic printing method is used in the present invention.

Flexographic printing is a printing method in which a certain amount of a resin adhesive is filled into cells of the anilox roller, the filled resin adhesive is then transferred to a printing cylinder or printing plate, and the resin adhesive transferred to the printing cylinder or printing plate is transferred to a rapidly quenched soft magnetic alloy ribbon.

### Flexographic Printing Method

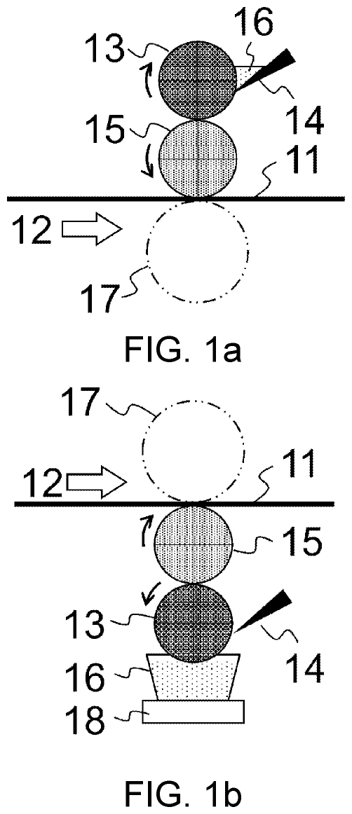

FIG. 1a to FIG. 1c are examples of a form of a flexographic printing device. With reference to FIG. 1a and FIG. 1b, a flexographic printing type basic application method will be described.

The flexographic printing method is mainly composed of an anilox roller 13 whose outer circumferential surface has numerous fine recesses (hereinafter referred to as cells), a doctor blade (thin blade) 14, and a printing cylinder 15. That is, at the same time as a thin ribbon 11 advances from the left to the right on the plane of the paper (in the direction of the arrow 12), the anilox roller 13 and the printing cylinder 15 rotate. During this time, within a resin adhesive 16 adhered to the surface of the anilox roller 13, an excess liquid agent that has not entered the cells is scraped off by the doctor blade 14, and the resin adhesive 16 remaining in the cells is then transferred to the outer circumferential surface of the printing cylinder 15, and transferred to the thin ribbon 11 for printing. According to this method, it is possible to perform printing with a uniform coating thickness both in the width direction and in the direction of travel.

For example, as shown in FIG. 1a, a form in which the flexographic printing device stores the resin adhesive 16 in a space formed by the doctor blade 14 and the anilox roller 13 (liquid reservoir), and when the anilox roller 13 rotates downward (toward the tip of the doctor blade 14) from the liquid reservoir, the resin adhesive transferred to the printing cylinder 15 thereunder may be used, and as shown in FIG. 1b, a form in which the anilox roller 13 is arranged so that it comes into contact with the liquid level of the resin adhesive 16 in the container thereunder, and as the anilox roller 13 rotates, the adhered resin adhesive 16 is lifted and transferred to the printing cylinder 15 may be used. In this case, for example, the resin adhesive 16 may be heated when a heater 18 is arranged on the bottom of the container containing the resin adhesive 16.

In the forms shown in FIG. 1a and FIG. 1b, application can be performed by fixing the position of the flexographic printing device and transporting the thin ribbon 11 as a printing material. In this case, a support roller 17 is provided on the side of the thin ribbon 11 that is not in contact with the printing cylinder 15, the thin ribbon 11 is interposed between the support roller 17 and the printing cylinder 15, which are pressed together, and thus stable transportation becomes easier. This form is effective when thin ribbons are continuously transported in a roll-to-roll manner.

On the other hand, application can be performed by moving the flexographic printing device to the thin ribbon 11 placed on a foundation. This form is effective when a thin ribbon cut to a predetermined length is printed.

That is, in the form of flexographic printing shown in FIG. 1a and FIG. 1b, the thin ribbon may be endless in the length direction or the thin ribbon that is cut to a predetermined length may be used.

The form shown in FIG. 1c is effective when flexographic printing is performed on the thin ribbon cut to a predetermined length. FIG. 1c includes three steps. That is, there are a step of performing application from the anilox roller 13 to a dummy sheet 19 to obtain a coating 20 of a resin adhesive, a step of pressing a printing plate 21 against the coating 20 of the resin adhesive and transferring the resin adhesive to the printing plate 21, and a step of printing by pressing the side of the printing plate 21 to which a liquid agent is applied against the thin ribbon 11. The case of this form is different from that of FIG. 1a and FIG. 1b in that the dummy sheet 19 is passed through and the printing plate 20 does not have a roller shape, but the application principle is the same, and thus this case is also a form of the flexographic printing method.

The cell shapes of the anilox roller are generally a quadrangular pyramid shape (also known as a pyramid shape; whose surface is square and has a V shape in the depth direction), a lattice-shape (whose surface is square and has a trapezoid with the apex of a pyramid cut in the depth direction), a tortoiseshell shape (whose surface is a honeycomb type and has a trapezoid shape in the depth direction), a circular shape (having a hemispherical shape in the depth direction) and the like. Each of these cells is partitioned by partition walls, and can store a small amount of a resin adhesive. There are other cell shapes such as a diagonal shape (having a V-shaped groove in the depth direction), in which each cell is not partitioned. In the present embodiment, any cell shape can be used.

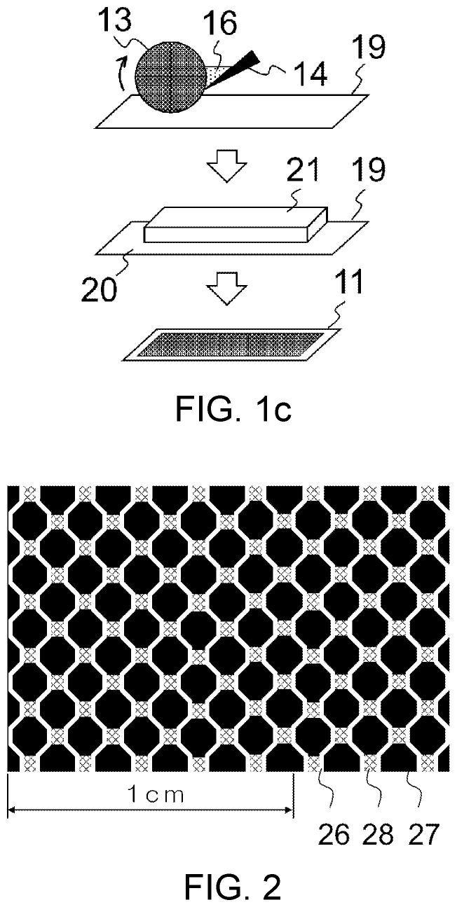

In addition, the cells may have a shape partially partitioned by partition walls. FIG. 2 shows an example in which the anilox roller has an octagonal cell shape. In this figure, partition walls 26 (white in this figure) forming the cells form a part of an octagonal external form, and are connected to adjacent partition walls to form a waveform in one direction (a vertical direction in this figure) as a whole. Here, an octagonal groove 27 (black in this figure) is recessed in the depth direction, and an octagonal connecting part 28 (shaded in this figure) is a shallow groove. That is, adjacent octagonal cells are not completely partitioned. A cell having such a shape may also be used.

Although this is only an example, in the case of cell with a shape in FIG. 2, the depth of the groove is 5 μm to 300 μm, the number of wires forming the cell is 10 to 500 lines/cm, and the volume can be selected from 1 to 100 cm³/m². For your reference, the standard length (1 cm) when the number of wires is 10 lines/cm is also shown in FIG. 2. The material of the anilox roller is not particularly limited, but it is preferably made of a metal or ceramic in order to prevent long-term deterioration.

As the material of the printing cylinder, for example, it is preferable to use an elastic member such as rubber because it can conform to the surface of the thin ribbon even if it is not flat. As for the type of rubber, for example, ethylene propylene diene rubber (EPDM) having water resistance and abrasion resistance is preferable.

Actual thin ribbons are not flat, and may have small irregularities (undulations) that are not visible, or both sides of the thin ribbon in the width direction may be wavy. Therefore, it is preferable to apply the resin adhesive by pressing the printing cylinder so that a load is equally applied from one end to the other end of the thin ribbon in the width direction and prevent the occurrence of a variation in the application amount between the center and both ends of the thin ribbon.

### Stacking Step

Another rapidly quenched soft magnetic alloy ribbon is stacked on a surface of the rapidly quenched soft magnetic alloy ribbon to which the resin adhesive is applied in the resin application step.

A pressure device may be used when thin ribbons are bonded together. The pressure device includes, for example, a pair of rollers. When the thin ribbons pass between the rollers, a pressing load is applied in a direction (bonding direction) perpendicular to the main surface of the thin ribbon, which makes it possible to firmly bond the thin ribbons together.

It is preferable that the pressing force of the roller be uniform in the width direction of the thin ribbon so that there is no in-plane distribution of the adhesive strength. Therefore, it is desirable that the axes of the pair of rollers be fixed precisely in parallel and the diameters of the rollers in the longitudinal direction be uniform. The pressing force can be applied by, for example, an air cylinder, a hydraulic cylinder, a spring or the like. The size of the pressing force is not particularly limited, and for example, it is preferably 10 kgf or more and 50 kgf or less when two thin ribbons with a width of 60 mm or 70 mm are stacked.

When at least two or more thin ribbons are stacked and enter between the rollers, the thin ribbons may shift laterally in the width direction. In order to prevent this, a jig that serves as a guide to align the edges of the thin ribbons in front of the roller in the transport direction and a mechanism for sensing the positions of the edges of the thin ribbons and correcting the positions so that the positions of the edges remain constant may be provided.

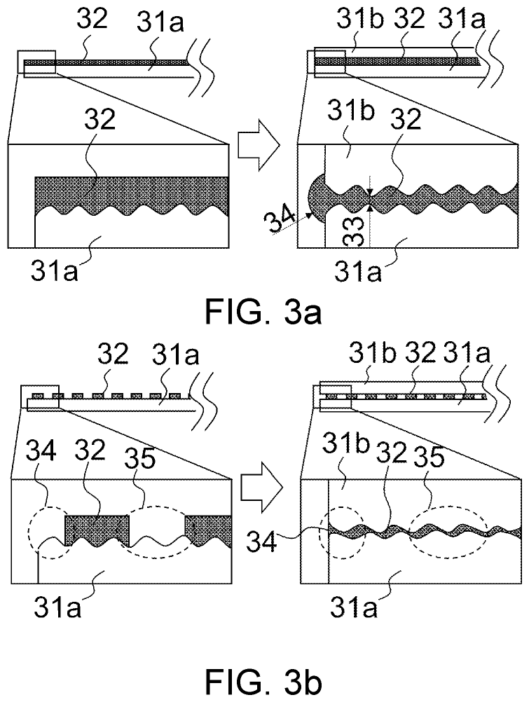

Here, the film thickness of the resin adhesive applied in the resin application step after the stacking step will be described with reference to FIG. 3a and FIG. 3b. FIG. 3a and FIG. 3b are examples of a schematic cross-sectional view of the rapidly quenched soft magnetic alloy ribbon to which the resin adhesive is applied.

The resin adhesive may be applied uniformly over the entire surface of the thin ribbon without any gaps or may be applied in a pattern. However, as shown in the enlarged view of FIG. 3a, the surface of a thin ribbon 31a is not flat but has irregularities (undulations). When a resin adhesive 32 is applied to the entire surface of the thin ribbon 31a in the resin application step, and another thin ribbon 31b is then stacked in the stacking step, the thickness of the resin adhesive 32 is thick and tends to vary. In addition, in an area in which the thin ribbons are close to each other (for example, an area 33), too much resin adhesive is pushed out toward the outer circumference of the thin ribbon, and tends to overflow from an edge 34 of the thin ribbon.

Since the overflowing resin adhesive will adhere to the surface of the pressure device and the back side of the thin ribbon, which makes the surface of the roller uneven, and causes excess resin adhesive to be adhered to the succeeding thin ribbon, it is preferable to prevent overflowing. Accordingly, instead of applying the resin adhesive to the edge of the thin ribbon as closely as possible, a method of applying the resin adhesive slightly inward is conceivable, but when another thin ribbon is bonded, there will be unevenness in the area in which the resin adhesive spreads to the edge and an area in which the resin adhesive does not spread, and adjustment is difficult.

On the other hand, as shown in FIG. 3b, in the resin application step, when the resin adhesive 32 is applied to a part of the surface of the thin ribbon 31a, since the resin adhesive 32 spreads into a gap 35 formed between the thin ribbon 31a and another thin ribbon 31b stacked in the stacking step, it is easy to make it thin and uniform. In addition, when the edge 34 of the thin ribbon is made into an unapplied area in an arbitrary width, the resin adhesive extruded from the inside of the thin ribbon will only spread and remain, and overflowing from the edge 34 of the thin ribbon is prevented.

That is, it is preferable that the outer circumferential surface of the printing cylinder have a convex part having an arbitrary pattern shape. Therefore, only the resin adhesive transferred from the anilox roller to the convex part of the printing cylinder is transferred to the thin ribbon, and a thin adhesive layer is obtained.

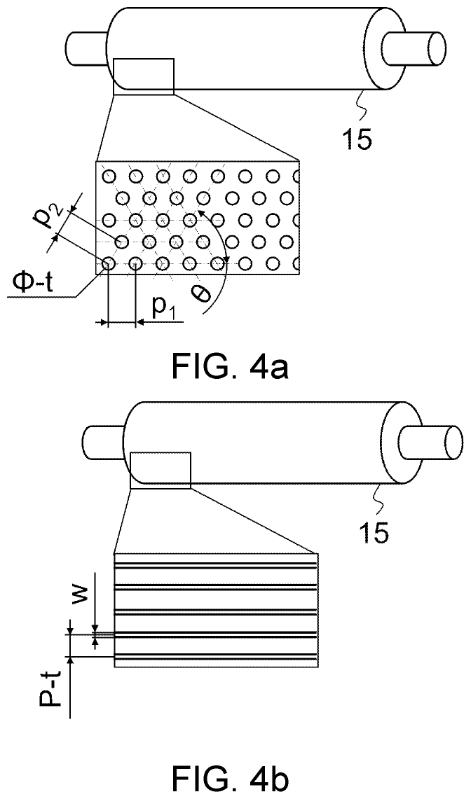

FIG. 4a and FIG. 4b show examples of a printing cylinder having a convex part having a predetermined pattern shape. The pattern is formed on the entire circumference of the cylindrical surface of the printing cylinder 15, but an enlarged part thereof is shown. The predetermined pattern shape is, for example, a dot shape as shown in FIG. 4a or a stripe shape as shown in FIG. 4b.

In the dot shape, circles having a diameter φ are arranged at intervals of a pitch p in a predetermined direction and in a direction changed by an angle θ from the predetermined direction. In this case, each dot is convex by a thickness t. As a modified example, for example, in this figure, the angle θ of the arrangement of the dots appears to be 60°, but it may be set to a different angle, and the pitch p (for example, a pitch p₁ of the printing cylinder in the longitudinal direction, a pitch p₂ in a direction changed by an angle θ from the longitudinal direction of the printing cylinder, etc.) may be a different distance, and the diameter φ, the pitch p, and the angle θ may not be constant.

In the stripe shape, convex shapes having a width w and a thickness t are arranged at intervals of the pitch p in the width direction of the printing cylinder. As a modified example, stripes may be formed in a direction in which the printing cylinder rotates or may be formed obliquely. In addition, it may be formed in a lattice shape in combination with the width direction and the rotation direction.

The printing cylinder may have a predetermined pattern shape on the surface of the roller, a sleeve having a predetermined pattern shape may be attached to the base of the roller, or a rubber plate having a predetermined pattern shape may be wound around the base of the roller.

### Heat Treatment Step

A multilayer body is obtained by heating rapidly quenched soft magnetic alloy ribbons stacked in the stacking step.

The resin adhesive is made by adding a curing agent to a low-molecular-weight compound and heating it, which causes a curing reaction, is converted into an insoluble and infusible high-molecular-weight compound, and firmly bonds adjacent thin ribbons together.

### Heating Method

Examples of methods for efficiently raising the temperature of the thin ribbon include a method of directly bringing a thin ribbon into contact with a heated metal member, a hot plate or the like. However, when the thin ribbon is continuously transported, if an object rubs the surface of the thin ribbon, the thin ribbon may break, and thus it is preferable to transport the thin ribbon between rollers. In the case of roller transport, there is line contact with the thin ribbon, which makes it difficult to heat it over a certain time range. Therefore, for example, a method for raising the temperature of the atmosphere around the thin ribbon using a halogen heater, a quartz glass tube heater or the like, and heating a multilayer body by the heat may be used. The method can be set according to the heating temperature and time, the type of the resin adhesive, and the like.

A specific heating temperature and holding time. (a) can be 60 seconds or longer and 180 seconds or shorter in a temperature range of Tg−10(° C.) or higher and Tg+5(° C.) or lower when the glass transition point is Tg. (b) can be 40 seconds or longer and 180 seconds or shorter in a temperature range of Tg+5(° C.) or higher and Tg+20(° C.) or lower when the glass transition point is Tg. (c) can be 25 seconds or longer and 180 seconds or shorter in a temperature range of Tg+20(° C.) or higher and Tg+40(° C.) or lower when the glass transition point is Tg. (d) can be 25 seconds or longer and 180 seconds or shorter in a temperature range of Tg−50(° C.) or higher and Tg+20(° C.) or lower when the glass transition point is Tg, and (e) can be 15 seconds or longer and 180 seconds or shorter at Tg+40(° C.) or higher (the glass transition point is Tg) when the temperature is 40° C. (Tg+40° C.) or higher than the glass transition point (Tg). When the heating temperature becomes high, since very short-time control is necessary, and time control becomes complicated, it is preferable that the glass transition point (Tg) do not exceed 60° C. (Tg+60° C.), and 50° C. (Tg+50° C.) or lower is more preferable.

Here, this holding includes not only maintaining a certain heating temperature but also a case in which, in a target temperature range, the temperature changes continuously or stepwise.

Under such heating and holding conditions, when the multilayer body of rapidly quenched soft magnetic alloy ribbons is heated and held, it is possible to produce the multilayer body with fewer bubble marks that tend to occur on the adhesive surface. This is because excess gas generated when the resin adhesive is heated evaporates in advance.

The resin application step, the stacking step, and the heat treatment step have been described above, but these steps can be performed in small quantities by cutting thin ribbons to an arbitrary length, for example, in order to prepare a test piece, and also can be performed in large quantities according to a continuous production method.

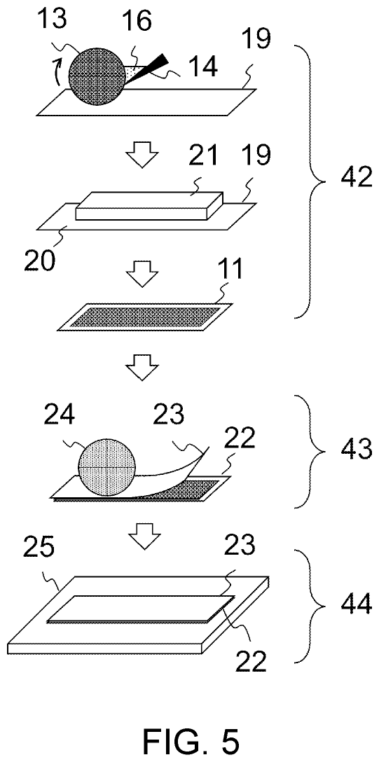

When a test piece is prepared, for example, as shown in FIG. 5, a resin application step 42, a stacking step 43, and a heat treatment step 44 are performed in this order. That is, the resin adhesive 16 is applied to the thin ribbon 11 according to the form of the above flexographic printing device shown in FIG. 1c, a thin ribbon 23 to which no resin adhesive is applied is stacked on the obtained thin ribbon (a thin ribbon 22 to which the resin adhesive is applied) (hereinafter simply referred to as the thin ribbons 22 and 23), the thin ribbons are then bonded together by applying a load to a pressing roller 24 in a direction (bonding direction) perpendicular to the main surfaces of the thin ribbons 22 and 23, the bonded thin ribbons 22 and 23 are heated by placing them on a heated metal member 25, and thereby a multilayer body can be obtained. The number of thin ribbons may be any number, and in the case of two or more thin ribbons, the series of steps may be repeated.

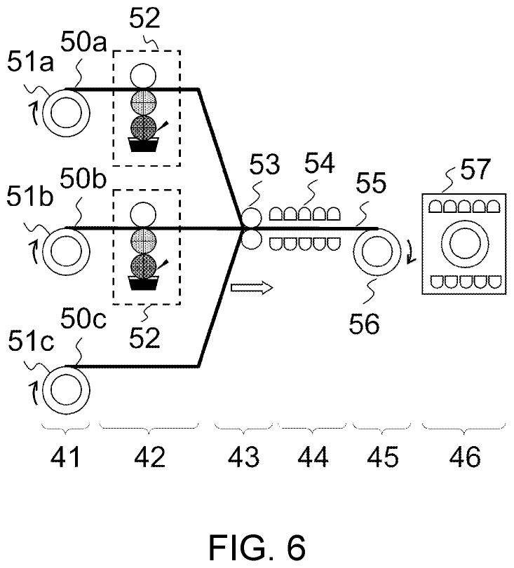

On the other hand, FIG. 6 shows an example of a step of producing a multilayer body according to a continuous production method. A thin ribbon 50 passes, from the left to the right on the plane of the paper, through an unwinding step 41, the resin application step 42, the stacking step 43, the heat treatment step 44, and a winding step 45 in this order. After the winding step 45, an additional heating treatment step 46 may be added.

That is, the production method shown in FIG. 6 is a method for producing a multilayer body of soft magnetic alloy thin ribbons, including a unwinding step in which the rapidly quenched soft magnetic alloy ribbon is unwound from a coil-shaped wound body, a resin application step in which a resin adhesive is applied to at least one surface of at least one rapidly quenched soft magnetic alloy ribbon unwound in the unwinding step, a stacking step in which, on the surface of the rapidly quenched soft magnetic alloy ribbon to which the resin adhesive is applied in the resin application step, another rapidly quenched soft magnetic alloy ribbon is stacked, a heat treatment step in which the rapidly quenched soft magnetic alloy ribbons stacked in the stacking step are heated and bonded together to obtain a multilayer body, and a winding step in which the multilayer body is wound into a coil to form a wound multilayer body.

Furthermore, the production method shown in FIG. 6 is a method for producing a multilayer body of soft magnetic alloy thin ribbons, including an unwinding step in which the rapidly quenched soft magnetic alloy ribbon is unwound from a coil-shaped wound body, a resin application step in which a resin adhesive is applied to at least one surface of at least one rapidly quenched soft magnetic alloy ribbon unwound in the unwinding step while continuous transporting, a stacking step in which, on the surface of the rapidly quenched soft magnetic alloy ribbon to which the resin adhesive is applied in the resin application step, another rapidly quenched soft magnetic alloy ribbon is stacked while continuous transporting, a heat treatment step in which the rapidly quenched soft magnetic alloy ribbons stacked in the stacking step are heated and bonded together to obtain a multilayer body while continuous transporting, and a winding step in which the multilayer body is wound into a coil without applying any mechanical processing such as cutting or punching to form a wound multilayer body.

FIG. 6 is an example of an apparatus for producing a multilayer body according to a continuous production method. When the diagram is viewed as a production apparatus, the unwinding step can be thought of as an unwinding unit, the resin application step can be thought of as a resin application unit, the stacking step can be thought of as a stacking unit, the heat treatment step can be thought of as a heat treatment unit, the additional heating treatment step can be thought of as an additional heating treatment unit, and the winding step can be thought of as a winding unit.

That is, the production apparatus shown in FIG. 6 includes a resin application unit configured to apply a resin adhesive to at least one surface of at least one rapidly quenched soft magnetic alloy ribbon, a stacking unit configured to stack, on the surface of the rapidly quenched soft magnetic alloy ribbon to which the resin adhesive is applied by the resin application unit. another rapidly quenched soft magnetic alloy ribbon, and a heat treatment unit configured to heat and bond the rapidly quenched soft magnetic alloy ribbons stacked by the stacking unit to obtain a multilayer body.

In addition, an unwinding unit is provided before the resin application unit, a winding unit is provided after the heat treatment unit, and roll-to-roll continuous transport is possible.

That is, the production apparatus shown in FIG. 6 is an apparatus for producing a multilayer body of soft magnetic alloy thin ribbons, including an unwinding unit configured to unwind a rapidly quenched soft magnetic alloy ribbon from a coil-shaped wound body, a resin application unit configured to apply a resin adhesive to at least one surface of at least one rapidly quenched soft magnetic alloy ribbon, a stacking unit configured to stack, on the surface of the rapidly quenched soft magnetic alloy ribbon to which the resin adhesive is applied by the resin application unit, another rapidly quenched soft magnetic alloy ribbon, a heat treatment unit configured to heat and bond the rapidly quenched soft magnetic alloy ribbons stacked by the stacking unit to obtain a multilayer body, and a winding unit configured to wind the multilayer body into a coil to form a wound multilayer body.

Although the size of the thin ribbon 50 is not particularly limited, it is assumed to have a thickness of about 10 to 50 μm and a width of about 10 to 250 mm. The number of thin ribbons 50 may be 2, 3 or more. For the configuration of the apparatus, when the number of thin ribbons 50 increases, an unwinding reel 51 and a printing device 52 may be added. However, when the thickness of a multilayer body 55 increases, since it is difficult to bend it appropriately, and there is a risk of the multilayer body 55 not being wound up by a winding reel 56, the thickness of the multilayer body 55 is desirably, for example, 600 μm or less.

An example in which three thin ribbons are used will be described in more detail. First, in the unwinding step 41, the thin ribbons 50 (50a, 50b, 50c) are unwound from the unwinding reels 51 (51a, 51b, 51c). Next, in the resin application step 42, a resin as an adhesive is applied to the thin ribbon using the flexographic printing device 52. Then, in the stacking step 43, the thin ribbons 50a, 50b and 50c are stacked, and bonded together by a pressure device 53 pressing in a direction perpendicular to the main surface of the thin ribbon (in a bonding direction and in a vertical direction perpendicular to a transport direction). In addition, the bonded thin ribbons are heated to a predetermined temperature directly or indirectly (for example, using a heater 54) in the heat treatment step 44, and the temperature is maintained to obtain a multilayer body 55. Finally, in the winding step 45, the multilayer body 55 is wounded into a coil.

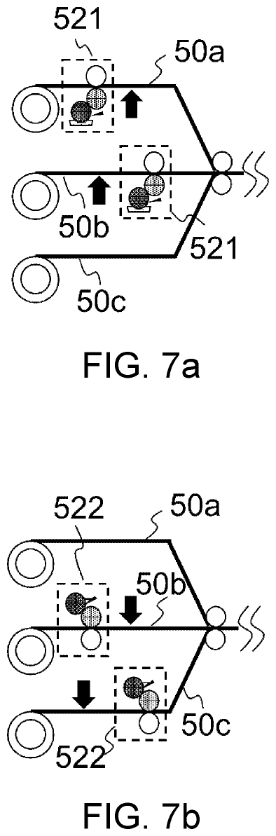

When there are three thin ribbons, there are four possible combinations of surfaces to which the resin adhesive is applied, as shown in FIG. 7a to FIG. 7d. That is, the resin adhesive is applied to the bottom surface of the thin ribbons 50a and 50b as shown in FIG. 7a, the resin adhesive is applied to the top surface of the thin ribbons 50b and 50c as shown in FIG. 7b, the resin adhesive is applied to the bottom surface of the thin ribbon 50a and the top surface of the thin ribbon 50c as shown in FIG. 7c, and the resin adhesive is applied to the both surfaces of the thin ribbon 50b as shown in FIG. 7d. The arrows in FIG. 7a to FIG. 7d indicate the surfaces to which the resin adhesive is applied.

Regarding the printing device for the resin application step, since there are a case in which the resin adhesive is applied to the bottom surface of the thin ribbon, a case in which the resin adhesive is applied to the top surface, and a case in which the resin adhesive is applied to both surfaces as described above, it is preferable to design a printing device 521 for bottom surface coating, a printing device 522 for top surface coating, and a printing device 523 for both-surface coating in consideration of necessity.

### Additional Heating Treatment Step

The multilayer body of the soft magnetic alloy thin ribbons obtained after the above heat treatment step has a certain peel strength (strength against a peeling force at 90 degrees or 180 degrees to the adhesive surface) and a shear force (strength against a force parallel to the adhesive surface), and additionally, when an additional heating treatment is performed in another heating furnace, the curing progress of the adhesive is promoted, and an auxiliary effect of insufficient heating and an increase in adhesive strength can be expected. In addition, when the roll-to-roll heating step is shortened and the sample is completely cured by additional heating after winding over a time, it is expected to simplify heating facilities, lower costs, and speed up the process. Heating conditions are preferably 40° C. to 240° C. for 1 hour or longer.

### Evaluation Method

### Peel Strength Measurement Method

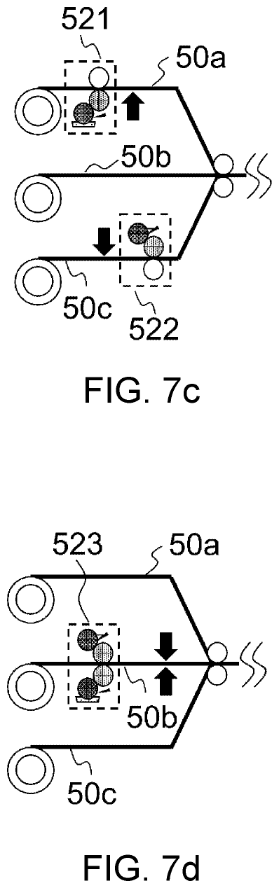

The peel strength of the multilayer body is measured using a peel strength testing machine produced with reference to the principle of the 180-degree peel strength test method (JISZ0237: 2009). FIG. 8 shows an example of an external view of the 180-degree peel testing machine. In this figure, a multilayer body 60 includes a thin ribbon 61a and a thin ribbon 61b.

In the measurement method, the surface of the thin ribbon 61a to which no resin adhesive is applied is fixed to a metal base 62 using a double-sided tape 63, and one edge of the multilayer body 61b is turned over and grasped with a clip 64. The clip 64 is hooked onto a tip hook of a force gauge 66 fixed on a linear guide 65. Then, the load when the force gauge 66 is slid is measured, and this is used as the peel strength of the multilayer body 61.

### EXAMPLES

### Example 1

Examples of the present invention will be described below. In the experimental method of Example 1, using a flexographic printing type printing device (FlexiProof 100, commercially available from RK Print Coat Instruments Ltd.), a resin serving as an adhesive was applied to a rapidly quenched soft magnetic alloy ribbon at room temperature.

As the thin ribbon, an Fe-based amorphous alloy thin ribbon 2605HBIM material with a thickness of 25 μm, a width of 60 mm, and a length of 200 mm was used. As the resin adhesive, 3 types of epoxy resins with a viscosity of 160, 2,000, and 21,000 mPa·s were used at room temperature.

The cells of the anilox roller were of octagonal shapes shown in FIG. 2 and had 55 lines/cm (a cell volume of 18 cm³/m²) and 200 lines/cm (a cell volume of 5 cm³/m²). The outer circumferential surface of the printing cylinder that was used had no convex part (one coated uniformly over the entire surface without any gaps). The application speed of the printing device was 20, 40, and 60 m/min. After the resin adhesive was applied to the thin ribbon, the thin ribbon was heated without stacking, the resin was cured, and the film thickness was measured. Table 1 shows the manufacturers, models, and heating conditions of the resins.

TABLE 1

| | | Viscosity | |
|---|---|---|---|
| Manufacturer | Adhesive | (mPa · s) | Heating conditions |
| Nagase ChemteX | XNR-4207 | 160 | 120° C./60 min |
| Corporation | | | |
| SOMAR Corporation | E-530 | 2,000 | 150° C./60 min |
| Nagase ChemteX | XNR3688 | 21,000 | 160° C./5 min |
| Corporation | | | |

### Experiment Results

Table 2 shows the measured film thickness. At the viscosity of 160 and 2,000 mPa·s. no difference in film thickness was observed even if the viscosity of the resin adhesive or the transport speed was changed. It was found that the film thickness was smaller as the cell volume of the anilox roller was smaller. Under any conditions, a film thickness of 4 μm or less could be obtained. When the viscosity was 12,000 mPa·s, the film thickness was thicker than at other viscosities. Additional examination was required to determine whether the effect was due to a high viscosity of the resin or due to a short heating time, but under both conditions, a film thickness of 7 μm or less could be obtained.

TABLE 2

Coating density m/min

| Viscosity mPa · s | Anilox cm³/m² | 20 | 40 | 60 |
|---|---|---|---|---|
| 160 | 18 | 3.5 | 3.8 | 3.5 |
| | 5 | 1.2 | 1.0 | 1.2 |
| 2,000 | 18 | 4.0 | 4.0 | 3.8 |
| | 5 | 1.8 | 2.0 | 1.9 |
| 21,000 | 18 | 6.3 | 4.5 | 3.8 |

unit: μm

### Example 2

As the experimental device, a continuous stacking device produced by the inventors was used. Specifically, as shown in FIG. 6, a device configured to continuously perform an unwinding step, a resin application step, a stacking step, a heat treatment step, and a winding step was produced, two thin ribbon coils were set on the unwinding reel, a resin adhesive was applied to one surface of one thin ribbon by flexographic printing, the thin ribbons were bonded together by a pressure device and heated, and the multilayer body was wound up by a winding reel.

As the thin ribbon, an Fe-based amorphous alloy thin ribbon 2605HBIM material with a thickness of about 25 μm and a width of 60 mm and 70 mm (commercially available from Hitachi Metals. Ltd.) was used. As the resin adhesive, an epoxy resin (E-530, commercially available from SOMAR Corporation) was used at room temperature.

The cells of the anilox roller were of octagonal shapes shown in FIG. 2 and had 140 lines/cm (a cell volume of 20.2 cm³/m²). Two types of printing cylinders were used: one with no convex part on the outer circumferential surface and capable of coating on the entire surface (material: urethane), and one with a dot pattern (material: EPDM). The dot pattern had φ of 0.5 mm, a thickness t of 0.5 mm, and a pitch p of 1.0 mm, and the pattern arrangement angle θ was 60°. The area of the printing cylinder in contact with the thin ribbon calculated from this (hereinafter referred to as a coating area) was about 22% of the entire thin ribbon.

When the thin ribbons were bonded together, they were interposed between two rollers, and pressed using a spring force. The transport speed of the thin ribbon was 3 m/min.

The heat treatment was performed at a temperature of 200° C. and the heating time including a temperature rising time was 100 seconds. The film thickness, the space factor, and the peel strength were measured after a measurement sample was cut out from the multilayer body after winding.

In addition, a part of the multilayer body was cut out, placed on a hot plate, and subjected to an additional heating treatment at 180° C. for 24 hours, and the peel strength was measured again.

### Experiment Results

The multilayer body was cut into a length of 150 mm, and the thickness was measured using a digital length measuring device (MH-15M, commercially available from Nikon

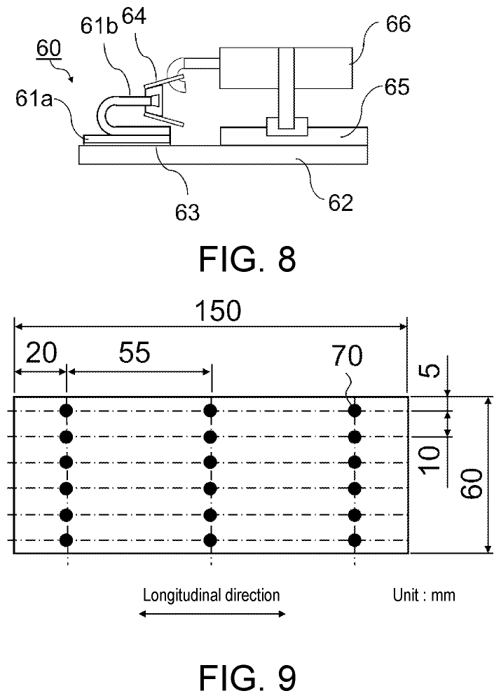

Corporation). FIG. 9 shows measurement points when the width of the thin ribbon was 60 mm. Measurement points 70 were 18 points (6 points in the width direction×3 points in the longitudinal direction) at a 10 mm-pitch in the width direction from a position 5 mm from the edge in the width direction (a total of 6 points) and at a 55 mm-pitch from a position 20 mm from the edge in the longitudinal direction (a total of 3 points). When the width was 70 mm, the measurement points were 21 points (7 points in the width direction×3 points in the longitudinal direction) at the same pitch.

In the procedure, the thickness of one thin ribbon before stacking was measured at the above measurement points, an average value t1 was determined, this value was doubled, the difference between it and an average value t2 of the thicknesses after stacking was obtained, and the average value of the thicknesses of the resin adhesive w was determined (w=t2−t1×2).

The average value of the thicknesses was assigned into the space factor calculation formula described above to determine a space factor.

A 180-degree peel testing machine was produced and set as shown in FIG. 8, the peel strength was measured, and the value when the load was a maximum was a representative value of the peel strength.

Table 3 shows the measurement results. The film thickness of the resin adhesive was thin, and in all cases, the space factor was a high value of 95% or more. The film thickness average value was 1.35 μm for the entire surface coating, and 0.32 μm for the dot pattern, and the ratio was 23.7% (=0.32/1.35). The film thickness was approximately proportional to the coating area. When the dot pattern was used, the average film thickness became thinner than expected, but it was conceivable that the film thickness could be adjusted to a desired value by changing specifications (making the dots larger and narrowing the pitch) of the dot pattern.

The peel strength after winding was a high value such as 7.21 gf/mm when the entire surface was coated. In the case of the dot pattern, the peel strength decreased to 1.07 gf/mm, but a value of 1.0 gf/mm or more, which is a level of practically no problem, was obtained. Here, it was conceivable that the peel strength could be additionally adjusted by changing the specifications of the dot pattern.

In the case of the entire surface coating, the peel strength after additional heating was lower than the peel strength after winding. This was thought to be because curing of the resin adhesive had progressed. It was confirmed that, even in such a cured state, 1.0 gf/mm or more was obtained.

TABLE 3

| | | After stacking and heating treatment | | | | |
|---|---|---|---|---|---|---|
| | | | | | | Peel |
| | | Average | Variation | | Peel | strength |
| | | film | in film | | strength | after |
| Ribbon | Conditions | thick- | thickness | Space | after | additional |
| width | Printing | ness | 3σ | factor | winding | heating |
| mm | cylinder | μm | μm | % | gf/mm | gf/mm |
| 60 | Entire | 1.35 | 2.56 | 97.4 | 7.21 | 1.33 |
| | surface | | | | | |
| | (coating | | | | | |
| | area 100%) | | | | | |
| 70 | Dot pattern | 0.32 | 2.04 | 99.4 | 1.07 | |
| | (coating | | | | | |
| | area 22%) | | | | | |

As described above, according to the present invention, it is possible to provide a method for producing a multilayer body having a high space factor by applying a resin adhesive to rapidly quenched soft magnetic alloy ribbons by flexographic printing, bonding them together, and heating them.

### REFERENCE SIGNS LIST

11 Thin ribbon
12 Direction of travel
13 Anilox roller
14 Doctor blade
15 Printing cylinder
16 Resin adhesive
17 Support roller
18 Heater
19 Dummy sheet
20 Coating of resin adhesive
21 Printing plate
22 Thin ribbon to which resin adhesive is applied
23 Thin ribbon to which no resin adhesive is applied
24 Pressing roller
25 Heated metal member
26 Cell partition wall
27 Cell groove
28 Connecting part of cell groove
31 Thin ribbon
32 Resin adhesive (adhesive layer)
33 Area in which thin ribbons are close to each other
34 Edge of thin ribbon
35 Gap formed between two thin ribbons
36 Rubber sheet
37 Metal roller
41 Unwinding step
42 Resin application step
43 Stacking step
44 Heat treatment step
45 Winding step
46 Additional heating treatment step
50 Rapidly quenched soft magnetic alloy ribbon
51 Unwinding reel
52 Printing device
521 Printing device of bottom surface coating
522 Printing device for top surface coating
523 Printing device for both-surface coating
53 Pressure device
54 Heater
55 Multilayer body
56 Winding reel
60 Multilayer body
61 Thin ribbon
62 Metal base
63 Double-sided tape
64 Clip
65 Linear guide
66 Force gauge
70 Thickness measurement point p Pattern pitch t Pattern thickness w Stripe pattern width φ Dot pattern diameter θ Angle of dot pattern arrangement

1-5. (canceled)

6. A method for producing a multilayer body of rapidly quenched soft magnetic alloy ribbons, in which a plurality of rapidly quenched soft magnetic alloy ribbons having a thickness of 10 to 50 μm and a width of 10 to 250 mm are bonded together, comprising:
a resin application step in which a resin adhesive, which is an epoxy resin, is applied to at least one surface of at least one rapidly quenched soft magnetic alloy ribbon without being diluted with organic solvents;
a stacking step in which, on the surface of the rapidly quenched soft magnetic alloy ribbon to which the resin adhesive is applied in the resin application step, another rapidly quenched soft magnetic alloy ribbon is stacked; and
a heat treatment step in which the rapidly quenched soft magnetic alloy ribbons stacked in the stacking step are heated and bonded together to obtain a multilayer body,
wherein the resin adhesive has a viscosity of 0.1 Pa·s or more, and
a method for applying the resin adhesive is a flexographic printing method.

7. The method for producing a multilayer body of rapidly quenched soft magnetic alloy ribbons according to claim 6,
wherein the resin application step, the stacking step, and the heat treatment step are performed while continuous transporting the rapidly quenched soft magnetic alloy ribbon.

8. The method for producing a multilayer body of rapidly quenched soft magnetic alloy ribbons according to claim 6,
wherein an edge of the rapidly quenched soft magnetic alloy ribbon is made into an unapplied area of the resin adhesive.

9. The method for producing a multilayer body of rapidly quenched soft magnetic alloy ribbons according to claim 7,
wherein an edge of the rapidly quenched soft magnetic alloy ribbon is made into an unapplied area of the resin adhesive.

10. The method for producing a multilayer body of rapidly quenched soft magnetic alloy ribbons according to claim 8,
wherein, in the flexographic printing method, an elastic member having a plurality of convex parts is used for a printing cylinder to apply the resin adhesive as a dot pattern, and the applied resin adhesive is spread in the stacking step to integrate the resin adhesive.

11. The method for producing a multilayer body of rapidly quenched soft magnetic alloy ribbons according to claim 9,
wherein, in the flexographic printing method, an elastic member having a plurality of convex parts is used for a printing cylinder to apply the resin adhesive as a dot pattern, and the applied resin adhesive is spread in the stacking step to integrate the resin adhesive.

12. The method for producing a multilayer body of rapidly quenched soft magnetic alloy ribbons according to claim 6, comprising,
an unwinding step in which the rapidly quenched soft magnetic alloy ribbon is unwound from a coil-shaped wound body before the resin application step, and
a winding step in which the multilayer body is wound into a coil to form a wound multilayer body after the heat treatment step.

13. The method for producing a multilayer body of rapidly quenched soft magnetic alloy ribbons according to claim 7, comprising,
an unwinding step in which the rapidly quenched soft magnetic alloy ribbon is unwound from a coil-shaped wound body before the resin application step, and
a winding step in which the multilayer body is wound into a coil to form a wound multilayer body after the heat treatment step.

14. The method for producing a multilayer body of rapidly quenched soft magnetic alloy ribbons according to claim 6,
wherein the multilayer body after the heat treatment step is made into a wound body, and an additional heating treatment step in which an additional heating treatment is performed to heat the wound body is included.

15. The method for producing a multilayer body of rapidly quenched soft magnetic alloy ribbons according to claim 7,
wherein the multilayer body after the heat treatment step is made into a wound body, and an additional heating treatment step in which an additional heating treatment is performed to heat the wound body is included.

16. An apparatus for producing a multilayer body of rapidly quenched soft magnetic alloy ribbons, in which a plurality of rapidly quenched soft magnetic alloy ribbons having a thickness of about 10 to 50 μm and a width of about 10 to 250 mm are bonded together, comprising:
a resin application unit configured to apply a resin adhesive, which is an epoxy resin, to at least one surface of at least one rapidly quenched soft magnetic alloy ribbon without being diluted with organic solvents;
a stacking unit configured to stack, on the surface of the rapidly quenched soft magnetic alloy ribbon to which the resin adhesive is applied by the resin application unit, another rapidly quenched soft magnetic alloy ribbon; and
a heat treatment unit configured to heat and bond the rapidly quenched soft magnetic alloy ribbons stacked by the stacking unit to obtain a multilayer body,
wherein the resin adhesive has a viscosity of 0.1 Pa·s or more, and
an apparatus for applying the resin adhesive is a flexographic printing method.
